(19) United States
(12) Patent Application Publication
(10) Pub. No.: US 2014/0310484 A1
(43) Pub. Date: Oct. 16, 2014

(54) SYSTEM AND METHOD FOR GLOBALLY ADDRESSABLE GPU MEMORY

(71) Applicant: NVIDIA Corporation, Santa Clara, CA (US)

(72) Inventor: Olivier GIROUX, San Jose, CA (US)

(73) Assignee: NVIDIA Corporation, Santa Clara, CA (US)

(21) Appl. No.: 13/864,182

(22) Filed: Apr. 16, 2013

(51) Int. Cl. G06F 3/06

(52) U.S. Cl. CPC G06F 3/0611; G06F 3/0629; G06F 3/0671
USPC 711/154; 711/170

(57) ABSTRACT

A system and method for efficient memory access. The method includes receiving a request to access a portion of memory. The request comprises a first address. The method further includes determining whether the first address corresponds to a thread local portion of memory and in response to the first address corresponding to the thread local portion of memory, translating the first address to a second address. The method further includes accessing the thread local portion of memory based on the second address. The second address corresponds to an offset in a region of memory reserved for storing thread local data and allocations into the region are contiguous for a plurality of threads at each thread local offset.

### FIELD OF THE INVENTION

Embodiments of the present invention are generally related to graphics processing units (GPUs) and GPU memory.

### BACKGROUND OF THE INVENTION

As computer systems have advanced, graphics processing units (GPUs) have become increasingly advanced both in complexity and computing power. As a result of this increase in processing power, GPUs are now capable of executing both graphics processing and more general computing tasks. The ability to execute general computing tasks on a GPU has lead to increased development of programs that execute general computing tasks on a GPU. A general-purpose computing on graphics processing units program or GPGPU program executing general computing tasks on a GPU has a host portion executing on a central processing unit (CPU) and a device portion executing on the GPU.

GPUs generally have a parallel architecture allowing a computing task to be divided into smaller pieces known as threads. The threads may then execute in parallel as a group. Each of the threads may execute the same instruction at the same time. For example, if a group of 32 threads is executing, when the 32 threads attempt to access a variable, there will be 32 load requests at the same time. A memory subsystem of the GPU cannot handle 32 requests for unrelated or scattered addresses efficiently.

Data in the memory subsystem of the GPU may be declared at different types of scopes according to the programming language used. For instance, variables can be declared at a global scope which gives visibility to all functions and threads that are running in a program. Variables can also be declared at the local scope meaning that the variable is visible to the body of a function. A programming language may further allow a pointer to a local variable and the pointer to be passed through a globally visible state thereby allowing another thread or function to access the local variable.

Programming languages, such as C and C++, often have constraints as to how memory storage for a program is organized. C and C++ require that an allocation occupy contiguous bytes or addresses that are sequential. In other words, addresses are monotomically increasing for individual allocations of memory. C and C++ further require that each thread must be able to dereference the allocations that every other thread has made. C and C++ also require that no two memory allocations can have the same address such that each allocation of memory has a distinct address. These requirements may result in memory allocations for a group of threads to be scattered throughout memory and therefore memory operations for a group of threads executing in parallel to be inefficient.

One conventional solution has been to disallow sharable pointers to interleave contiguous allocations so that the same byte offset into each of the threads' allocations are contiguous in memory which results in good performance. However, this solution puts multiple allocations at the same address and thereby is inconsistent with programming language memory rules. Another conventional solution has distinct addresses, sharable pointers, and does not put two allocations in the same address but has very low performance.

### SUMMARY OF THE INVENTION

Accordingly, what is needed is a solution to allow data to be accessed efficiently by a group of threads which are executing while being compliant with memory allocation requirements of the programming language (e.g., C and C++) being used. Embodiments of the present invention are operable to define a region of global memory with global and unique addressability for access by the group of threads. Embodiments of the present invention thereby allows each thread of a group of threads to access the memory (e.g., thread local memory) of each other thread (e.g., via dereferencing a pointer). Embodiments of the present invention are operable to allow translation in the path of dereferencing memory thereby allowing data for a given offset of each of a plurality of threads to be adjacent and contiguous in memory. The global memory is thereby organized (e.g., swizzled) in a manner suitable for use as thread stack memory. Embodiments of the present invention further add addressing capabilities for global memory instructions suitable for stack offset addressing. Current local memory implementations and load local and store local instructions can be used concurrently with embodiments of the present invention.

In one embodiment, the present invention is directed to a method for efficient memory access. The method includes receiving a request to access a portion of memory. The request comprises a first address. The method further includes determining whether the first address corresponds to a thread local portion of memory and in response to the first address corresponding to the thread local portion of memory, translating the first address to a second address. The second address corresponds to an offset in the region of memory reserved for storing thread local data and allocations into the region are contiguous for a plurality of threads at each thread local offset. In one embodiment, the determining whether the first address corresponds to the local portion of memory is based on a bit of the first address.

In one exemplary embodiment, the translating is based on a first set of bits of the first address and a second set of bits of the first address. The translating may comprise swapping the first set of bits of the first address and the second set of bits of the first address. In another exemplary embodiment, the translation is based on a page table. The translating may be performed prior to sending the second address to a memory management unit. The memory management unit may be operable to return the contiguous portion of the thread local memory in a single operation. In one embodiment, the first address is received from a memory management unit. The method further includes accessing the thread local portion of memory based on the second address.

In one embodiment, the present invention is directed toward a method for configuring memory for access. The method includes accessing a portion of an executable program and generating a group of threads comprising a plurality of threads based on the portion of the executable program. The method further includes assigning each thread of the plurality of threads a respective unique identifier and allocating a respective portion of local memory to each of the plurality of threads, where the respective portion of local memory is operable to be accessed by each of the plurality of threads. Each respective portion of local memory comprises a respective contiguous portion corresponding to an offset for each thread of the plurality of threads. The respective unique identifier may operable for determining a respective base address of the respective portion of local memory corresponding to a respective thread.

Each respective contiguous portion may be contiguous for data stored for the group of threads for the offset. In one exemplary embodiment, the respective contiguous portion is operable to be accessed based on a translated address. In another exemplary embodiment, the respective contiguous portion is operable to be accessed based on a page table. In one embodiment, the plurality of threads is operable to concurrently request access to the respective contiguous portion corresponding to the offset. Each respective contiguous portion corresponding to the offset may be operable to be returned in a single operation. The method may further include assigning each thread of the group of threads a group identifier.

In another embodiment, the present invention is implemented as a system for efficient memory access. The system includes an access request module operable to receive a plurality of memory requests from a plurality of threads and a memory determination module operable to determine whether each address of the plurality of memory requests corresponds to a predetermined portion of memory. Each of the plurality of threads may execute in lock step. The system further includes a translation module operable to translate each respective address of the plurality of memory requests to a respective translated address for each address of the plurality of memory requests corresponding to the predetermined portion of memory. Within the predetermined portion of memory each respective address corresponds to a respective offset of a respective base address of each of the plurality of threads and each memory location corresponding to the respective offset is contiguous. In one exemplary embodiment, the translation module is operable to translate each address of the plurality of memory requests based on a bit of each respective address of the plurality of memory requests. In another exemplary embodiment, the translation module is operable to translate each respective address of the plurality of memory requests based a page table.

The system further includes an access module operable to perform the plurality of memory requests. In one embodiment, the access module is operable to respond to the plurality of memory requests in a single operation if each respective translated address corresponds to a contiguous portion of memory.

### BRIEF DESCRIPTION OF THE DRAWINGS

Embodiments of the present invention are illustrated by way of example, and not by way of limitation, in the figures of the accompanying drawings and in which like reference numerals refer to similar elements.

FIG. 1 shows an exemplary computer system in accordance with one embodiment of the present invention.

FIG. 2 shows a block diagram of exemplary components of a graphics processing unit (GPU) in accordance with one embodiment of the present invention.

FIG. 3 shows a block diagram of an exemplary address translation in accordance with one embodiment of the present invention.

FIG. 4 shows a block diagram of exemplary address fields in accordance with one embodiment of the present invention.

FIG. 5 shows a block diagram of an exemplary organization of memory in accordance with one embodiment of the present invention.

FIG. 6 shows a block diagram of an exemplary allocation dicing in accordance with one embodiment of the present invention.

FIG. 7 shows a flowchart of an exemplary computer controlled process for allocating memory in accordance with one embodiment of the present invention.

FIG. 8 shows a flowchart of an exemplary computer controlled process for accessing memory in accordance with one embodiment of the present invention.

FIG. 9 shows a block diagram of exemplary computer system and corresponding modules, in accordance with one embodiment of the present invention.

### DETAILED DESCRIPTION OF THE INVENTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the embodiments of the present invention.

### NOTATION AND NOMENCLATURE

Some portions of the detailed descriptions, which follow, are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

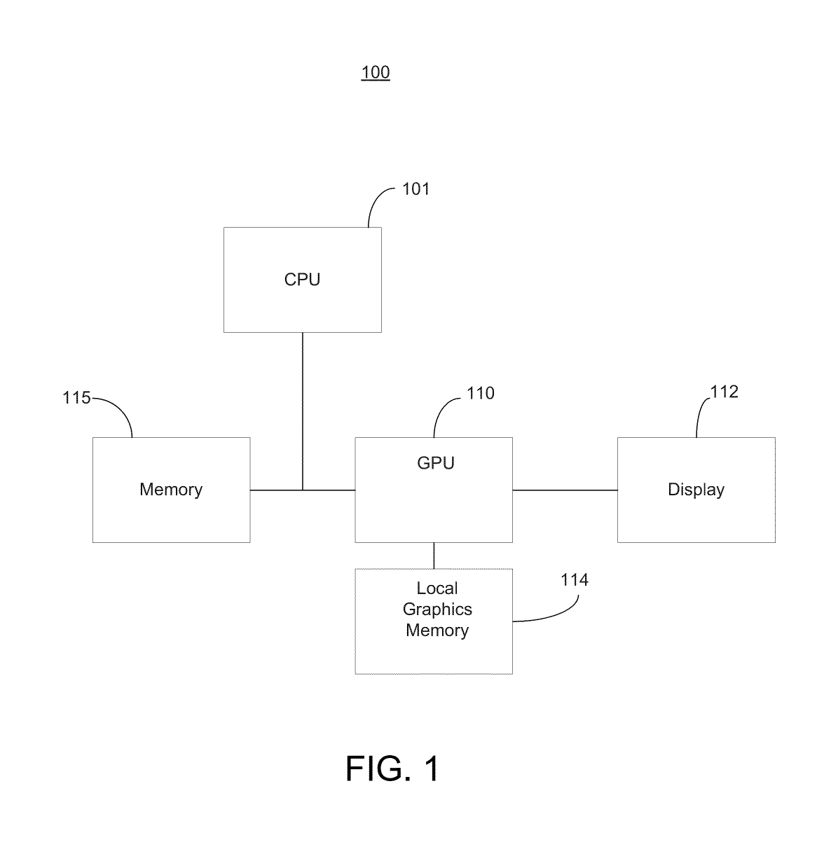

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of an integrated circuit (e.g., computing system 100 of FIG. 1), or similar electronic computing device, that manipulates and transforms data represented as physical (electronic) quantities within the computer system's registers and memories into other data similarly represented as physical quantities within the computer system memories or registers or other such information storage, transmission or display devices.

General-purpose computing on graphics processing units (GPGPU) programs or applications may be designed or written with the Compute Unified Device Architecture (CUDA) framework and Open Computing Language (OpenCL) framework. A GPGPU program may be referred to a CUDA or OpenCL program or application.

### Computer System Environment

FIG. 1 shows an exemplary computer system 100 in accordance with one embodiment of the present invention. Computer system 100 depicts the components of a basic computer system in accordance with embodiments of the present invention providing the execution platform for certain hardware-based and software-based functionality. In general, computer system 100 comprises at least one CPU 101, a system memory 115, and at least one graphics processor unit (GPU) 110. The CPU 101 can be coupled to the system memory 115 via a bridge component/memory controller (not shown) or can be directly coupled to the system memory 115 via a memory controller (not shown) internal to the CPU 101. The GPU 110 may be coupled to a display 112. One or more additional GPUs can optionally be coupled to system 100 to further increase its computational power. The GPU(s) 110 is coupled to the CPU 101 and the system memory 115. The GPU 110 can be implemented as a discrete component, a discrete graphics card designed to couple to the computer system 100 via a connector (e.g., AGP slot, PCI-Express slot, etc.), a discrete integrated circuit die (e.g., mounted directly on a motherboard), or as an integrated GPU included within the integrated circuit die of a computer system chipset component (not shown). Additionally, a local graphics memory 114 can be included for the GPU 110 for high bandwidth graphics data storage.

The CPU 101 and the GPU 110 can also be integrated into a single integrated circuit die and the CPU and GPU may share various resources, such as instruction logic, buffers, functional units and so on, or separate resources may be provided for graphics and general-purpose operations. The GPU may further be integrated into a core logic component. Accordingly, any or all the circuits and/or functionality described herein as being associated with the GPU 110 can also be implemented in, and performed by, a suitably equipped CPU 101. Additionally, while embodiments herein may make reference to a GPU, it should be noted that the described circuits and/or functionality can also be implemented and other types of processors (e.g., general purpose or other special-purpose coprocessors) or within a CPU.

System 100 can be implemented as, for example, a desktop computer system or server computer system having a powerful general-purpose CPU 101 coupled to a dedicated graphics rendering GPU 110. In such an embodiment, components can be included that add peripheral buses, specialized audio/video components, IO devices, and the like. Similarly, system 100 can be implemented as a handheld device (e.g., cellphone, etc.), direct broadcast satellite (DBS)/terrestrial set-top box or a set-top video game console device such as, for example, the Xbox®, available from Microsoft Corporation of Redmond, Wash., or the PlayStation3®, available from Sony Computer Entertainment Corporation of Tokyo, Japan. System 100 can also be implemented as a “system on a chip”, where the electronics (e.g., the components 101, 115, 110, 114, and the like) of a computing device are wholly contained within a single integrated circuit die. Examples include a hand-held instrument with a display, a car navigation system, a portable entertainment system, and the like.

In one exemplary embodiment, GPU 110 is operable for General-purpose computing on graphics processing units (GPGPU) computing. GPU 110 may execute Compute Unified Device Architecture (CUDA) programs and Open Computing Language (OpenCL) programs. It is appreciated that the parallel architecture of GPU 110 may have significant performance advantages over CPU 101.

### Exemplary Systems and Methods for Globally Addressable GPU Memory

Embodiments of the present invention are operable to define a region of global memory with global and unique addressability. Embodiments of the present invention allow each thread of a group of threads to access the memory (e.g., thread local memory) of each other thread (e.g., via dereferencing a pointer). Embodiments of the present invention are operable to allow translation in the path of dereferencing memory thereby allowing data for a given offset of each of a plurality of threads to be adjacent and contiguous in memory. The global memory is thereby organized (e.g., swizzled) in a manner suitable for use as thread stack memory. Embodiments of the present invention further add addressing capabilities for global memory instructions suitable for stack offset addressing. Current local memory implementations and load local and store local instructions can be used concurrently with embodiments of the present invention.

Embodiments of the present invention have efficient expression and satisfy memory requirements of modern programming languages (e.g., C and C++). In one embodiment, ISO C++ rules for memory are supported. Embodiments of the present invention further permit nested parallelism to pass stack data by reference. Advantageously, in one embodiment, the cost of the CUDA continuation trap handler is reduced in half. Embodiments of the present invention further allow stack allocations to grow on-demand (e.g., page fault handling in a manner similar to x86 unified memory access (UMA)) and fix CUDA correctness issues with stack allocation. Embodiments of the present invention are operable with configurations that allow the CPU and the GPU to trade pages freely and handle faults thereby permitting growth on-demand.

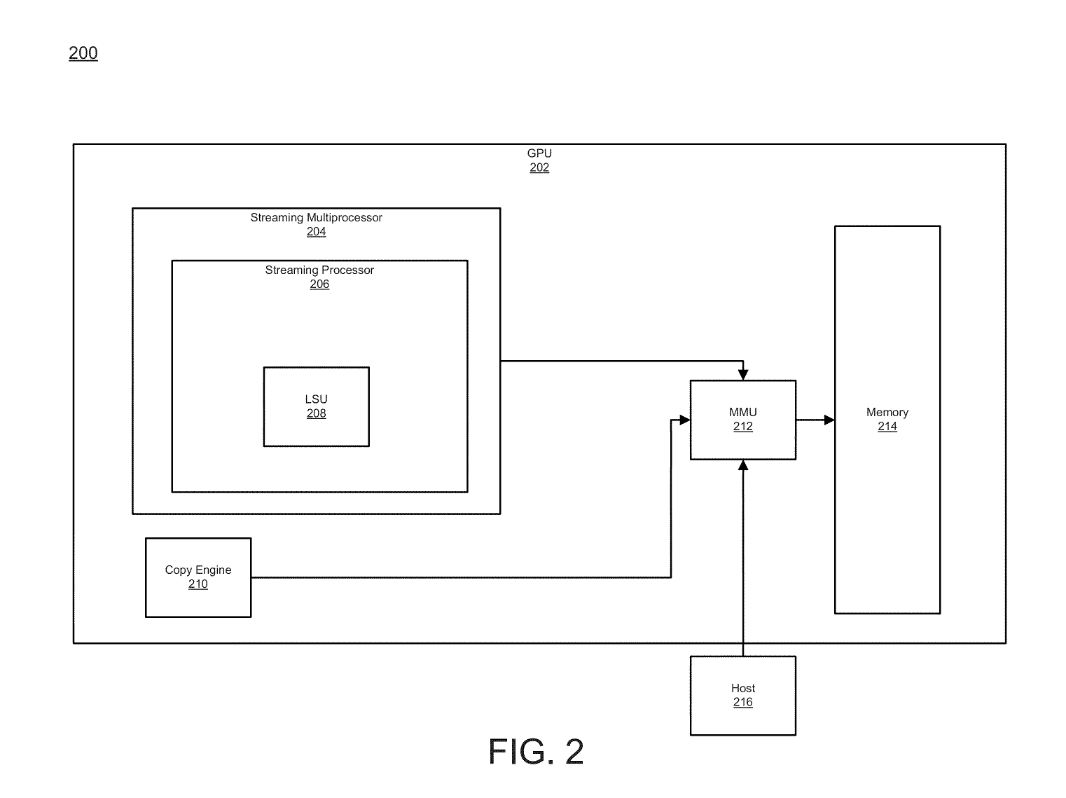

FIGS. 2-5 illustrate example components used by various embodiments of the present invention. Although specific components are disclosed in FIGS. 2-5, it should be appreciated that such components are exemplary. That is, embodiments of the present invention are well suited to having various other components or variations of the components recited in FIGS. 2-5. It is appreciated that the components in FIGS. 2-5 may operate with other components than those presented, and that not all of the components of FIGS. 2-5 may be required to achieve the goals of embodiments of the present invention.

FIG. 2 shows a block diagram of exemplary components of a graphics processing unit (GPU) in accordance with one embodiment of the present invention. The components shown in FIG. 2 of exemplary GPU 202 are exemplary and it is appreciated that a GPU may have more or less components than those shown. FIG. 2 depicts an exemplary GPU, exemplary memory related components, and exemplary communication of components of GPU 202. GPU 202 includes streaming multiprocessor 204, copy engine 210, memory management unit (MMU) 212, and memory 214.

It is noted that a GPU in accordance with embodiments of the present invention may have any number of streaming multiprocessors and is not limited to one streaming multiprocessor. It is further noted that a streaming multiprocessor in accordance with embodiments of the present invention may comprise any number of streaming processors and is not limited to one streaming processor or core.

Streaming multiprocessor 204 includes streaming processor 206. Streaming processor 206 is an execution unit operable to execution functions and computations for graphics processing or general computing tasks. Each streaming multiprocessor of streaming multiprocessor 206 may be assigned to execute a plurality of threads. For example, streaming multiprocessor 206 may be assigned a group or warp of 32 threads to execute (e.g. 32 threads to execute in parallel in lock step).

Each streaming processor of streaming multiprocessor may comprise a load and store unit (LSU) 208. LSU 208 is operable to send memory requests to memory management unit (MMU) 212 to allow streaming processor 206 to execute graphics operations or general computing operations/tasks.

Copy engine 210 is operable to perform move and copy operations for portions of GPU 202 by making requests to MMU 212. Copy engine 210 may allow GPU 202 to move or copy data (e.g., via DMA) to a variety of locations including system memory (e.g., memory 115) and memory 214 (e.g., memory 114) to facilitate operations of streaming multiprocessor 206.

Embodiments of the present invention may be incorporated into or performed by load and store unit (LSU) 208, copy engine 210, and memory management unit (MMU) 212. Embodiments of the present invention are operable to configure access to memory (e.g., memory 214) such that for a given offset from a respective base address of each thread of a group of threads, the data for the given offset is contiguous in memory 214.

Copy engine 210 may further be operable to facilitate context switching of threads executing on streaming multiprocessor 204. For example, a thread executing on streaming processor 206 may be context switched and the state of the thread stored in system memory (e.g., memory 115).

In one embodiment, copy engine 210 is operable to copy data to and from memory 214 (e.g., via MMU 212). Copy engine 210 may thus copy data for a thread out of a plurality of contiguous memory locations in memory 214 corresponding to each offset from a base address of the thread and store the data in system memory (e.g., memory 115) such that data for each offset from the base address of the thread is stored in a contiguous portion of system memory. Copy 210 may also copy data for a thread from a location in system memory (e.g., memory 115) and store the data in memory 214 such that data for each offset from a respective base address for a group of threads comprising the thread are stored in contiguous portions of memory 214.

Copy engine 214 may thus store data for a respective offset of each of a plurality of threads in a contiguous portion of memory 214. It is noted that contiguous portions of memory each corresponding to a respective offset may be spaced throughout memory 214. For example, different contiguous portions of memory each corresponding to different respective offsets may not be adjacent.

Memory management unit (MMU) 212 is operable to receive requests from LSU 208, copy engine 210, and host 216. In one embodiment, MMU 212 performs the requests (e.g., memory access requests) based on a translated or converted address such that the translated addresses correspond to data for an offset of a respective base address for each of a plurality of threads which are contiguous in memory 214. The contiguous portion of memory 214 can then be returned as a single response to the request unit. In one embodiment, MMU 212 is operable to retrieve the contiguous data for a given offset in a single operation. In one embodiment, MMU 212 is operable to issue a request to a DRAM memory which is operable to process multiple requests corresponding to a contiguous portion of memory in a single operation.

Host 216 may include a CPU (e.g., CPU 101) and be operable to execute a portion of a host portion of a GPGPU program. Host 216 is operable to send memory requests to memory management unit (MMU) 212. In one embodiment, memory access requests from a graphics driver are sent by host 216.

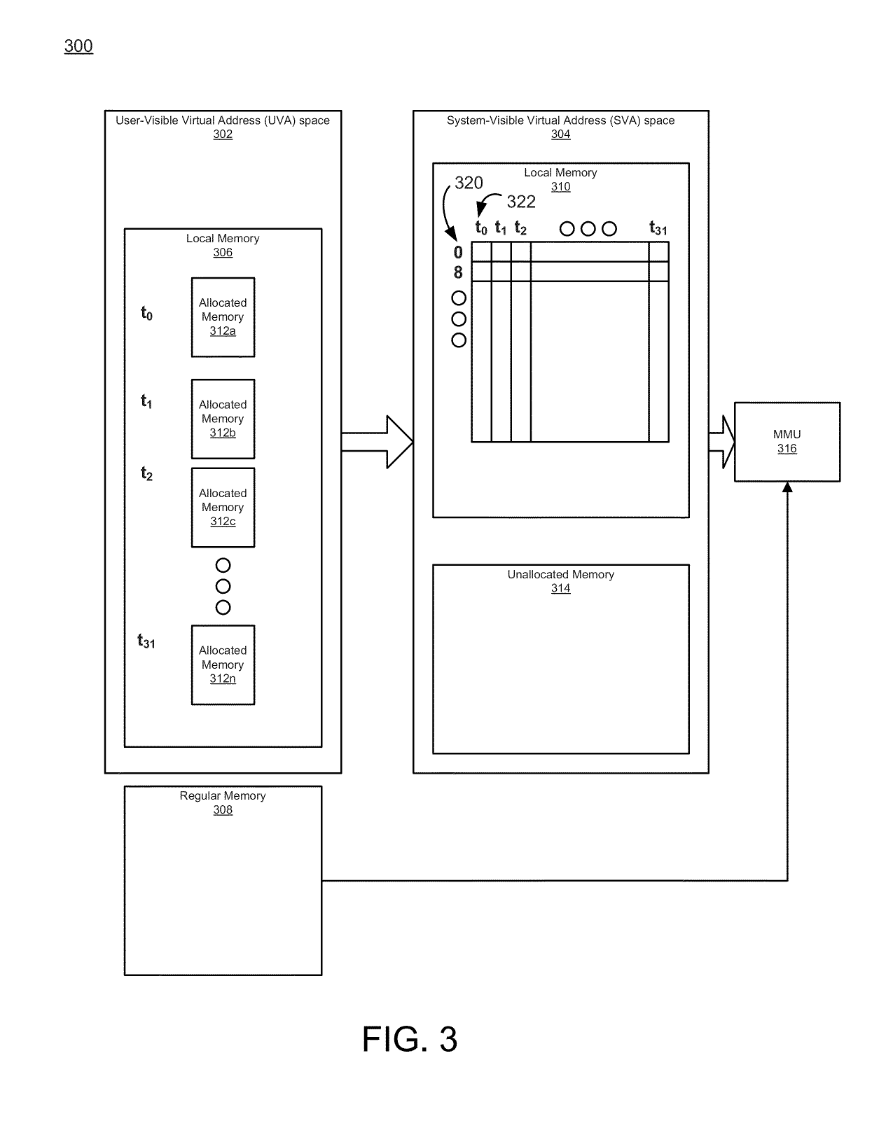

FIG. 3 shows a block diagram of an exemplary address translation in accordance with one embodiment of the present invention. FIG. 3 depicts translation from a user-visible virtual address (UVA) (e.g., program virtual address) of a memory access request to a system-visible virtual address (SVA) prior to accessing memory at a physical level based on the address of the memory access request. FIG. 3 is described with respect to a group of 32 threads. It is noted that embodiments of the present invention are operable to operate with any number of threads in a group (e.g., 16, 32, 64, 128, etc.).

User-visible virtual address (UVA) space 302 includes local memory 306. User-visible virtual address (UVA) space 302 is visible to an executing program (e.g., the GPU portion of a GPGPU program executing on GPU 202) and the corresponding threads of the executing program. In one embodiment, local memory 306 is memory allocated to a plurality of threads in a group or “warp” of threads. Allocated memory portions 312a-n are memory that is allocated to threads t₀-tₙ for use as local memory during execution of threads t₀-tₙ. Allocated memory portions 312a-n may be allocated for each thread based on a unique thread identifier and a unique thread identifier.

In one embodiment, allocated memory portions 312a-n represent contiguous portions of local memory 306 as allocated in accordance with a programming language (e.g., C or C++). Allocated memory portions 312a-n may be adjacent, have varying amounts of space between them, or some combination thereof. More specifically, it is noted that allocated memory portions 312a-n may be adjacent or non-adjacent and there may be allocations for other threads or spare portions of memory between allocated memory portions 312a-n.

Pointers to each of the allocated portions of local memory 306 may be shared with each thread of the group of threads thereby allowing each thread to access local memory of another thread.

Allocated memory portions 312a-n each have a unique start address within user-visible virtual address (UVA) space 302 and appear as contiguous regions to threads t₀-t₃₁. In one exemplary embodiment, allocated memory regions 312a-b each have a size of 128 bytes or 128 kilobytes. Embodiments of the present invention support memory allocated to each of a plurality of threads being any size. It is noted that the size of memory regions 312a-b allocated to each of threads may be based on the amount of local memory available.

Portions of local memory 306 may be allocated but unused when the number of threads is below a predetermined size of a group of threads. For example, with a thread group size of 32, when seven threads are to be executed, portions of memory allocated to the seven threads are used while corresponding portions of local memory 310 allocated for the 25 threads that are not present in the group of threads may be unused.

System-visible virtual address (SVA) space 304 includes local memory 310 and unallocated memory 314. User-visible virtual address (UVA) space 302 corresponds to or maps to system-visible virtual address (SVA) space 304. Embodiments of the present invention are operable to determine if an address of a memory access request (e.g., from a GPU portion of a GPGPU program) is within local memory 306 based on the received address. In one embodiment, whether the received address is within local memory 306 is determined based on the value (e.g., bit) of the address of the memory access request.

If the address of the memory access request is within local memory 306 (e.g., the most significant bit of the address is one), embodiments of the present invention are operable to translate the received address into an address within system-visible virtual address (SVA) space 304.

In another embodiment, the translation is done with an additional layer of page table. For example, the translation (e.g., exchanging of bits as described herein) may be performed on a page-per-page basis.

The translation may be performed before the regular virtual to physical translation of memory addresses in conventional systems. In one embodiment, the translation is performed after virtual to physical address translation of conventional systems.

The translation of the address from UVA space 302 to SVA space 304 thereby allows data for a given offset of each thread in the group of threads to be in a contiguous portion of memory. Local memory 310 may be described as “swizzled” memory meaning that contiguous portions of local memory 310 (e.g., a line of local memory 310) have data for a given offset for each of the plurality of threads. The size of the contiguous portion may be based on the number of threads in a group and the word size used. The contiguous portion of local memory 310 may have been allocated as local memory for a particular thread and are globally accessible by each thread of the corresponding group of threads. Thus, the swizzled memory includes a portion of thread local memory allocated for a particular thread but has data for a single offset for each thread of the group of threads corresponding to the particular thread. Sub-portions of the contiguous portion of local memory 310 having data for each thread for the given offset may be adjacent in the contiguous portion of local memory 310.

If the received address is not within local memory 306 (e.g., the most significant bit of the address is zero) and instead within regular memory 308, the request is sent to memory management unit 316. For example, for a 32 bit address space, using the most significant bit in the address to determine whether the address is in local memory divides the memory space into two gigabytes of regular memory and two gigabytes of local memory.

Local memory 310 of system-visible virtual address (SVA) space 304 is thus configured such that portions of memory for a given offset of the based address of each thread are contiguous. In one embodiment, each line of local memory 310 is represented by a contiguous portion of local memory 310 for an offset. An offset may thus be used as an index to access a particular line of local memory 310. For example, data for offset 320 or offset zero for each of threads t₀-t₃₁ is located in a contiguous portion (e.g., a contiguous line) of local memory 310 and with no space between the storage of each thread for the given offset. As another example, data for offset eight for each of threads t₀-t₃₁ is located in another contiguous portion (e.g., contiguous line) of local memory 310. If each offset was four bytes, the contiguous region for offset eight may begin at address 1024 of local memory 310. It is appreciated while portions of local memory 310 for offset zero and offset eight are depicted as contiguous, there may be space in local memory between the contiguous portions corresponding to offset zero and offset eight.

For example, if allocated memory portion 312a for thread t₀ begins at address 0, allocated memory portion 312b for thread t₁ begins at address 128, and allocated memory portion 312c for thread t₂ beings at address 256 in UVA space 302, then in SVA space 304 for 4 byte offsets, thread t₀'s first data storage location is at byte 0, thread t₁'s first data storage location is at byte 4, thread t₂'s first data storage location is at byte 8. In one embodiment, the storage of an offset for a plurality of threads is stored in a single page table thereby allowing the page to be transferred during context switching.

After a request is translated from user-visible virtual address (UVA) space 302 to system-visible virtual address space 304, the request is sent to MMU 316 with the system-visible virtual address from the translation process. MMU 316 then translates the SVA address into a physical memory address and the memory (e.g., memory 114) is accessed. In one embodiment, MMU 316 comprises a page table which defines a mapping of address from virtual to physical in blocks of pages (e.g., pages which can be some varying number of kilobytes).

The configuration of system-visible virtual address (SVA) space thus allows a group or gang of 32 threads executing together in lockstep to make 32 requests for a single offset to the memory system (e.g., MMU 316) at a single time. In one embodiment, MMU 316 is thereby able to handle the 32 requests in a single operation because MMU 316 is able to process requests for contiguous addresses that do not span multiple pages as a single operation. MMU 316 thus does not have to expand the 32 requests into more than one request because memory to be accessed for the single offset is a contiguous portion of memory. For example, if threads t₀-t₃₁ each have a loop variable (e.g., integer i), the values of the loop variables for thread t₀-t₃₁ will be next to each other in memory. MMU 316 is able to efficiently access contiguous addresses up to a page boundary because the addresses are contiguous in physical memory.

In one embodiment, local memory allocations for another group of threads (e.g., threads t₃₂-t₆₄) are placed in different portions of local memory 310 from the portions allocated for threads t₀-t₃₁. Local memory allocations in local memory 310 for different groups of threads may thus be adjacent, interleaved, spaced throughout memory, or some combination thereof.

Unallocated memory 314 may be used for allocation for threads of another group of thread or allocated on-demand for the treads t₀-t₃₁. Unallocated memory 314 may correspond to a spare portion (e.g., bit) of an address. For example, if t₀ is writing a plurality of values and wants to write to the next location which falls into an unallocated portion of the SVA address space, MMU 316 may generate a fault which is recognized by embodiments of the present invention which allocate a portion of unallocated memory 314 thereby creating a valid page. Thread t₀ may then be resumes execution and bit zero of the unallocated address portion may now have been allocated for t₀.

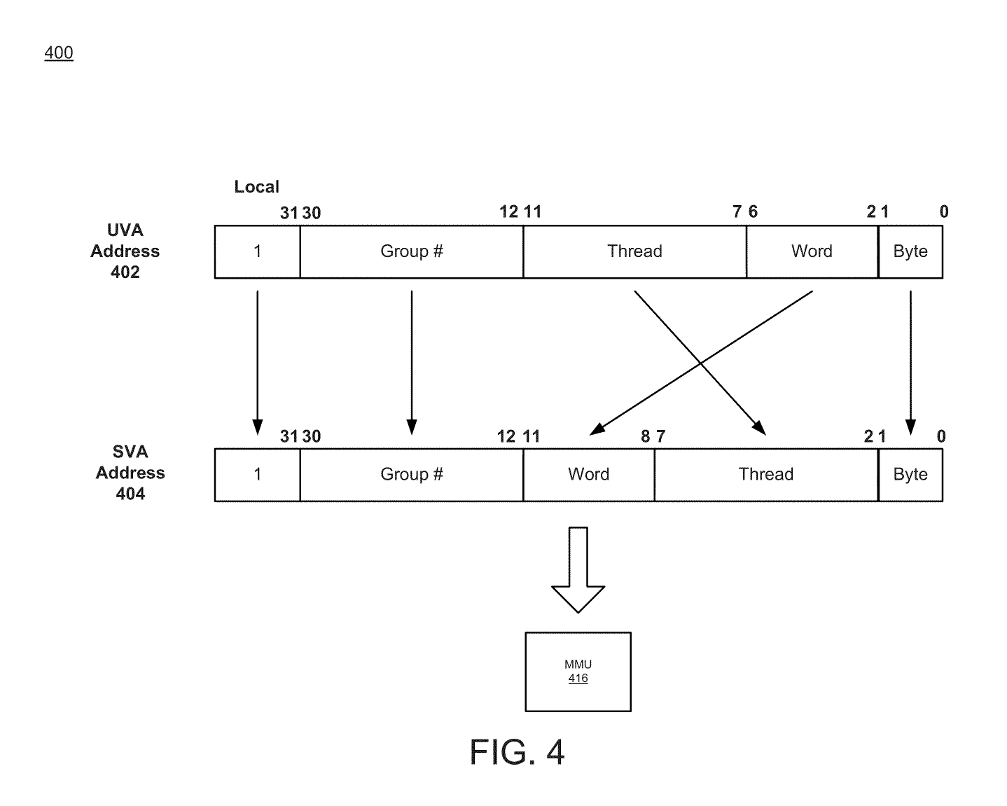

FIG. 4 shows a block diagram of exemplary address fields in accordance with one embodiment of the present invention. FIG. 4 depicts exemplary address fields of a user-visible virtual address (UVA) 402, system-visible virtual address 404, and an exemplary translation of the address fields. FIG. 4 depicts local memory as indicated by a first bit of an address field being one, such an indicator of local memory is exemplary. Embodiments of the present invention are operable to support local memory (e.g., globally accessible thread local memory) being indicated by one or more bits of an address, a range of values of bits within an address (e.g., a range three bits between 010 and 100), or a specific pattern of bits in an address (e.g., the most significant bits being 101). Embodiments of the present invention are thereby operable to use bits of an address to selectively access memory. For example, embodiment of the present invention use memory not used by an operating system (e.g., use addresses within a hole in an operating system memory map).

UVA address 402 includes byte bits 0-1, word bits 2-6, thread bits 7-11, group bits 12-30, and local bit 31. It is noted that UVA address 402 is the address that a program (e.g., program divided up into threads t₀-t₃₁) will use during execution. SVA address 404 includes byte bits 0-1, thread bits 2-7, word bits 8-11, group bits 12-30, and local bit 31. The number of bits in UVA address 402 and SVA address 404 is exemplary (e.g., not limited to 32 bits) and may be any number of bits. In one embodiment, the number of bits in UVA address 402 and SVA address 404 is based on the number of threads in a group of threads.

Group bits correspond to a unique group identifier (e.g., group serial number) of a group of threads (e.g., threads t₀-t₃₁). Each group of threads may have a different group identifier or group number. Thread bits correspond to a unique thread identifier that is assigned to each thread. It is noted that the group bits and thread bits may be least significant bits, most significant bits, or a portion of bits of a group identifier or group number or thread identifier or thread number. In one embodiment, the group bits and thread bits may be interleaved or spaced in non-adjacent portions of UVA address 402.

In one embodiment, translation from UVA address 402 to SVA address 404 comprises swapping or exchanging the thread bits of UVA address 402 with the words bits of UVA address 402 to produce SVA address 404. The swapping or exchanging results in the thread bits (e.g., thread identifier) becoming an index into the line of memory (e.g., line of local memory 310 for t₀) and the word bits becoming the row number (e.g., offset zero of local memory 310). SVA address 404 can then be sent to MMU 416 for accessing a contiguous portion of memory corresponding to a given offset from each respective base address of a plurality of threads.

Embodiments of the present invention support other exchanges of bits of UVA address 402. For example, if the threads are allocated a large amount of local memory, high bits may be exchanged with low bits. If the threads are allocated smaller amounts of memory, adjacent sets of five bits can be exchanged. In one exemplary embodiment, the number of bits swapped may be based on the how much local memory each thread is allocated. For example, the amount of memory allocated as local memory may be based on the number of threads supported the overall system at one time and thereby how many distinct regions that can be allocated for each thread. As another example, if 4096 byte pages are used (e.g., to facilitate context switching), the bits exchanged may correspond to 32×32 tiles of words (e.g., 32×32×4=4096).

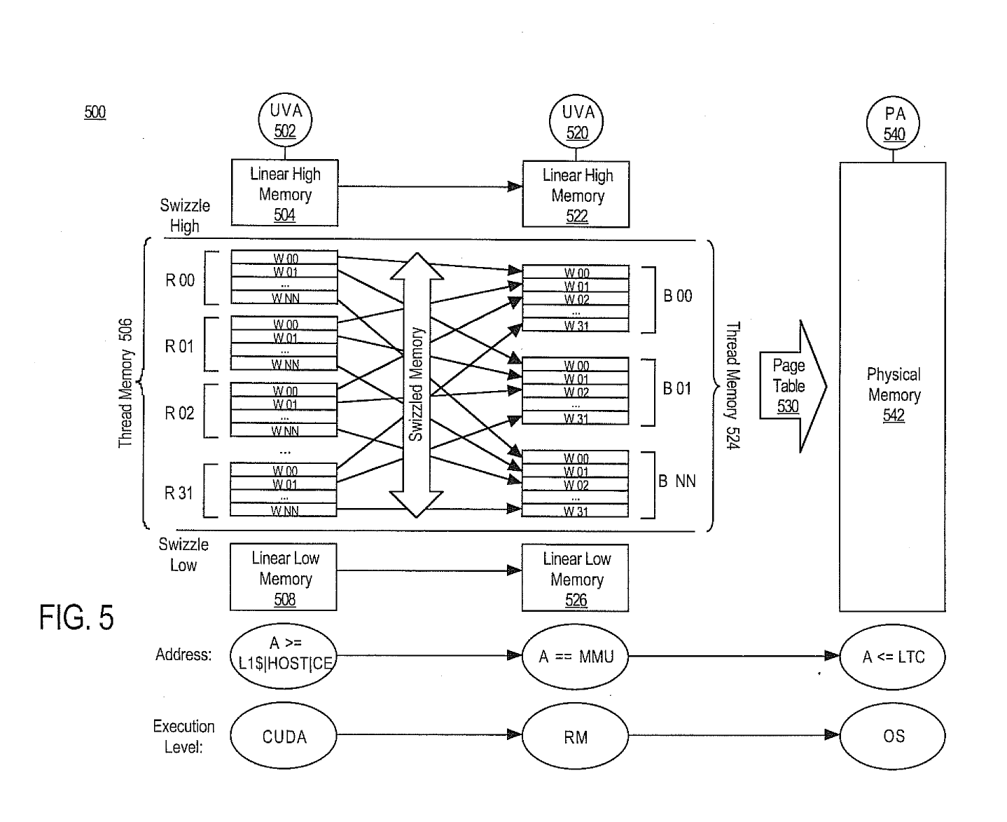

FIG. 5 shows a block diagram of an exemplary organization of memory in accordance with one embodiment of the present invention. FIG. 5 depicts an exemplary mapping of memory word locations within user-visible virtual address (UVA) space 502 and system-visible virtual address (SVA) space 520. In other words, FIG. 5 depicts an exemplary mapping of a memory location as a memory access request is processed through user-visible virtual address (UVA) space 502, system-visible virtual address (SVA) space 520, and physical address (PA) space 540. Diagram 500 includes user-visible virtual address (UVA) space 502, system-visible virtual address (SVA) space 520, and physical address (PA) space 540.

The regions of high linear memory 504, 522 and low linear memory 508, 526 are exemplary and it is appreciated that the thread memory regions 506, 524 for local memory by one or more groups of threads may be located anywhere in memory (e.g., top, bottom, or middle of memory).

User-visible virtual address (UVA) space 502 includes linear high memory 504, thread memory 506, and linear low memory 508. User-visible virtual address (UVA) space 502 is visible at a thread or program level (e.g., threads of a CUDA program). Thread memory 506 is globally accessed by one or more groups of threads. Thread memory 506 of UVA space 502 includes regions R 00-R 31. In one exemplary embodiment, each of regions R 00-R 31 are allocated memory for threads t₀-t₃₁, respectively. Regions R 00-R 31 may be 32 regions of equal size with each region having NN memory words (e.g., any number). Regions R 00-R 31 may be arranged as 32 words per region to a 4 KB page.

System-visible virtual address (SVA) space 520 includes linear high memory 522, thread memory 524, and linear low memory 526. In one embodiment, addresses in linear high memory 504 map directly to addresses in linear high memory 522 of SVA space 520. Addresses in linear low memory 508 may map directly to addresses in linear low memory 526 of SVA space 520. In one embodiment, addresses greater than or equal to the addresses of the L1 cache, host, or copy engine regions are processed using UVA space 502.

Addresses in thread memory 506 map to addresses within thread memory 524 (e.g., via translation). Thread memory 524 comprises a swizzled version of thread memory 506 such that contiguous portions of thread memory 524 (e.g., B 00-B NN) have the same word for each of regions R 00-R 31 stored in a contiguous manner. In other words, the arrows of FIG. 5 indicate assignment of given offsets in UVA space 502 to a different block in SVA space 520. Each of regions B 00-B NN represent contiguous regions of SVA space memory 520. For example, region B 00 of thread memory 524 includes word W 00 of region R 00, word W 00 of region R 01, word W 00 of R 02, through W 00 of region R 31. Region B 01 of thread memory 524 includes word W 01 of region R 00, word W 01 of region R 01, word W 01 of R 02, through W 01 of region R 31. Region B NN of thread memory 524 includes word W NN of region R 00, word W NN of region R 01, word W NN of R 02, through W NN of region R31.

In one embodiment, the address output by SVA space 520 is equal to the address an MMU will use to access page table 530. Processing of the memory access requests at the SVA space 520 level may be executed by a runtime module (e.g., CUDA runtime module).

Addresses that have been translated based on SVA space 520 memory are then sent to page table 530 and then processed using physical memory 542 of physical address (PA) space 540. Physical address (PA) space 540 includes physical memory 542 (e.g., DRAM). In one embodiment, processing of the memory access requests at the physical address space 540 is executed by an operating system. Addresses greater than or equal to the addresses of the L2 cache may be processed using physical address (PA) space 540.

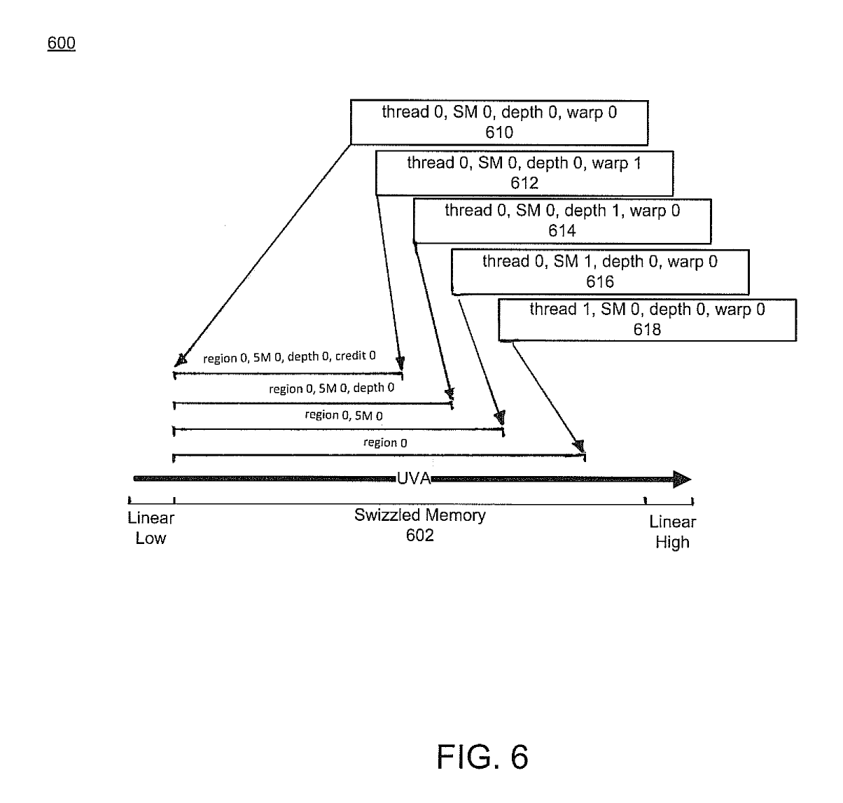

FIG. 6 shows a block diagram of an exemplary allocation dicing in accordance with one embodiment of the present invention. FIG. 6 depicts exemplary regions reserved in swizzled memory (e.g., thread memory 524) for a plurality of threads and a plurality of groups of threads.

Regions 610-618 are exemplary regions of swizzled memory 602 reserved for various threads. It is appreciated that the region sizes reserved can be as large as the address space allows and the regions can vary in size. Region 610 is a reservation of memory for thread t₀ of thread group zero with nested parallelism depth of zero and executing on streaming multiprocessor zero. Region 612 is a reservation of a region of memory for thread t₀ of thread group one with depth of zero and executing on streaming multiprocessor zero. Region 614 is a reservation of a region of memory for thread t₀ of thread group zero with depth of one and executing on streaming multiprocessor zero. Region 616 is a reservation of a region of memory for thread t₀ of thread group one with depth of zero and executing on streaming multiprocessor one. Region 618 is a reservation of a region of memory for thread t₁ of thread group zero with depth of zero and executing on streaming multiprocessor zero. In one exemplary embodiment, if a single 4 KB region is reserved per thread, the user-visible virtual address space window may be around 128 GB in size for a 32 streaming multiprocessor system.

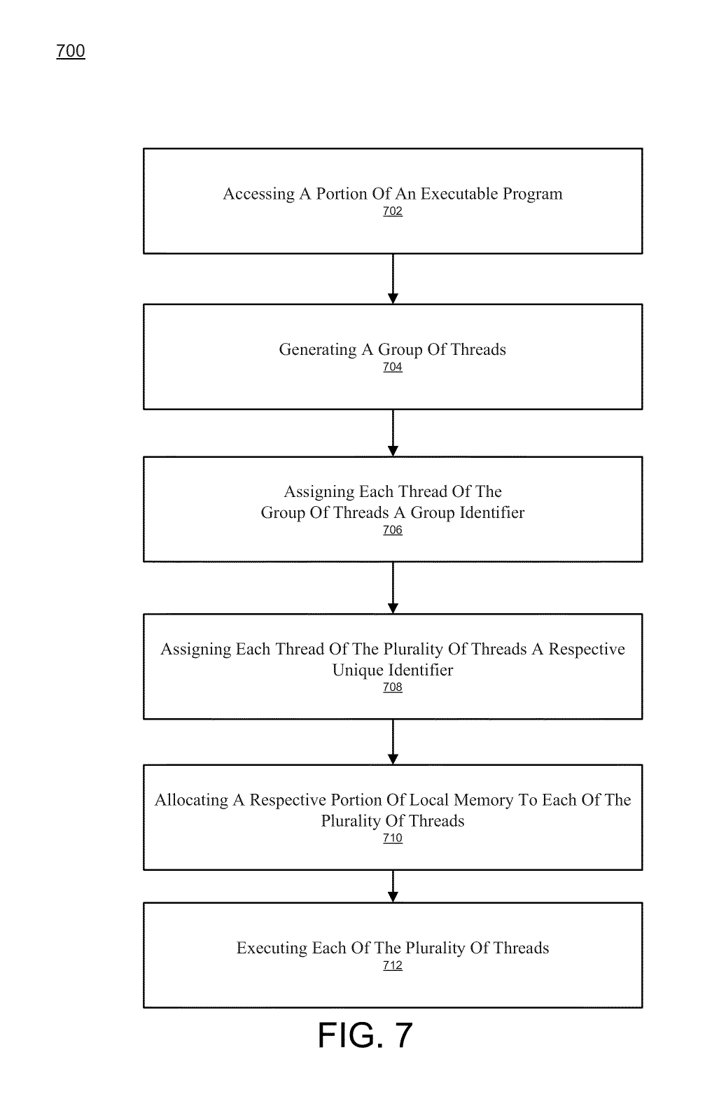

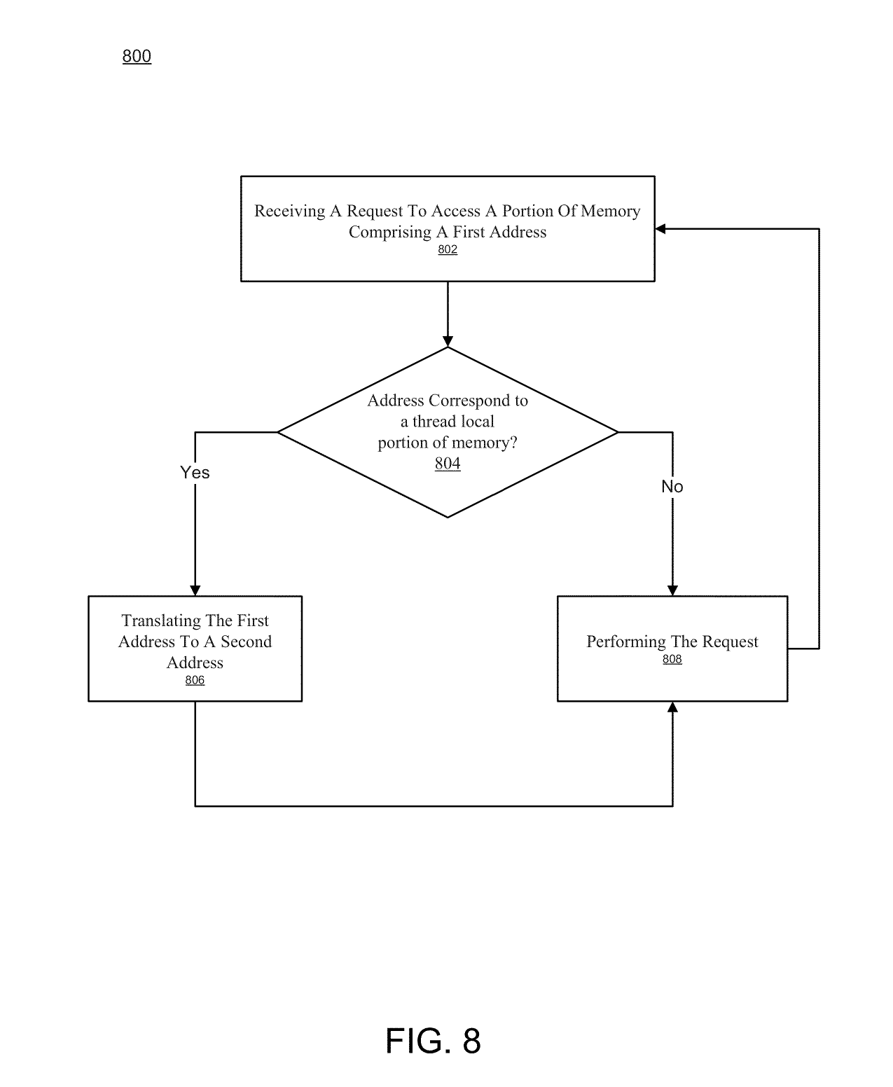

With reference to FIGS. 7 and 8, flowcharts 700 and 800 illustrate example functions used by various embodiments of the present invention for configuration and access of memory. Although specific function blocks (“blocks”) are disclosed in flowcharts 700 and 800, such steps are examples. That is, embodiments are well suited to performing various other blocks or variations of the blocks recited in flowcharts 700 and 800. It is appreciated that the blocks in flowcharts 700 and 800 may be performed in an order different than presented, and that not all of the blocks in flowcharts 700 and 800 may be performed.

FIG. 7 shows a flowchart of an exemplary computer controlled process for allocating memory in accordance with one embodiment of the present invention. Flowchart 700 depicts a process for configuring memory for efficient access by each thread of a group or warp of threads, as described herein.

At block 702, a portion of an executable program is accessed. In one embodiment, the portion of the executable program corresponds to executable code for a GPGPU program (e.g., CUDA or OpenCL code).

At block 704, a group of threads comprising a plurality of threads based on the portion of the executable program is generated.

At block 706, a unique group identifier is assigned to each of the threads based on the group of threads that a thread is in.

At block 708, each thread of the plurality of threads is assigned a respective unique identifier. In one exemplary embodiment, the group identifier is used as part of the identifier of each thread. The group identifier (e.g., bits) may be positioned in the identifier for each thread such that the group identifier contributes to the memory alignment property allowing the swapping of bits (e.g., as shown in FIG. 4), as described herein. In one embodiment, a unique serial number is assigned that is operable to allow unique identification of each thread currently in the GPU (e.g., executing on the GPU) and any threads that are in a dormant state in memory (e.g., context switched threads).

At block 710, a respective portion of local memory is allocated to each of the plurality of threads. Each respective unique identifier is operable for determining a respective base address of the respective portion of local memory corresponding to a respective thread. In one embodiment, each respective portion of local memory is operable to be accessed by each of the plurality of threads (e.g., local memory allocated to a first thread is globally accessible by the other threads of the plurality of threads). Each respective portion of local memory comprises a respective contiguous portion corresponding to an offset for each of thread of the plurality of threads. Each respective contiguous portion may be contiguous for the group of threads for the offset. In one embodiment, each of the plurality of threads is operable to concurrently request access to a respective contiguous portion corresponding to an offset.

Each value for a given offset in the contiguous portion of memory may be adjacent. Therefore, each respective contiguous portion corresponding to each of the plurality of offsets is operable to be returned in a single operation (e.g., by a memory controller or memory management unit).

In one exemplary embodiment, each respective contiguous portion is operable to be accessed based on a translated address, as described herein. In another embodiment, each respective contiguous portion is operable to be accessed based on a page table.

At block 712 of FIG. 7, the threads are executed. In one embodiment, the plurality of threads are executed in lockstep and thereby request access to a given offset from a respective base address at substantially the same time.

FIG. 8 shows a flowchart of an exemplary computer controlled process for accessing memory in accordance with one embodiment of the present invention. Flowchart 800 depicts a process for accessing memory in an efficient manner to handle the requests of a plurality of threads executing in parallel (e.g., and in lockstep).

At block 802, a request to access a portion of memory is received. The request comprises an address (e.g., a base address plus an offset) of memory to be accessed. The request may include a memory operation which may be a load, store, or an atomic read/write/modify operation.

At block 804, it is determined whether the address corresponds to a portion of thread local memory. If the address corresponds to a portion of thread local memory, block 806 is performed. If the address corresponds to a portion of memory other than thread local memory, block 808 is performed.

In one embodiment, whether the first address corresponds to a local portion of memory is based on a bit or bits of the first address. For example, whether the address is within local memory allocated to a thread of a plurality of threads may be determined based on a specific value of the top three bits of the address. It is appreciated that the region for local memory allocated to the group of threads may be determined at system bootup (e.g., system 100) and determined to not be part of a region assigned to an operating system.

At block 806, in response to the first address corresponding to the thread local portion of memory, the first address (e.g., address of the request) is translated to a second address. The translating may be based on a first set of bits of the first address and a second set of bits of the first address. In one exemplary embodiment, the translating comprises swapping or exchanging the first set of bits of the first address and the second set of bits of the first address. In another embodiment, translation is based on a page table. The number of bits used for the translation may be based on the number of threads in the group of threads. For example, for a group of threads having a larger number threads than 32, more than five bits may be exchanged.

At block 808, the request is performed. If the first address corresponds to a portion of thread local memory, the thread local portion of memory is accessed based on the second address. In one embodiment, the second address (or translated address) corresponds to an offset in the thread local portion of memory and a contiguous portion of the thread local memory comprises memory allocated for the offset for each of a plurality of threads. Thus, when each of a plurality of threads executing in lockstep issue respective requests each for a given offset, the response to each respective request can be advantageously performed based on a single memory access operation to access the contiguous portion of memory. In one embodiment, a memory management unit (MMU) is operable to return the contiguous portion of the thread local memory in a single operation. Advantageously, the access request for multiple pieces of memory thus corresponds to a contiguous portion of memory and the MMU can return the corresponding data to satisfy the request in a single response or transfer. Embodiments of the present invention are efficient at the memory level (e.g., with DRAM) when used with memory operable to return contiguous bytes of memory. Block 802 may then be performed.

In one embodiment, the translating is performed prior to sending the second address to a memory management unit. In another embodiment, the first address is received from a memory management unit and the translation is performed after processing of the request by the memory management unit.

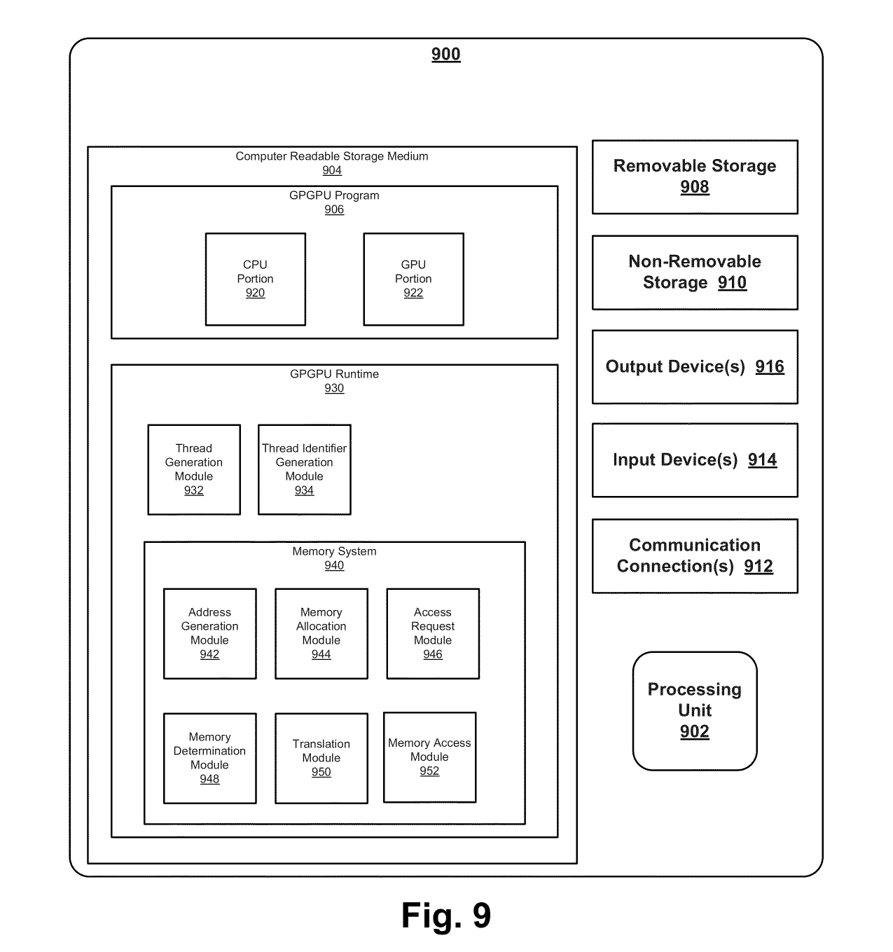

FIG. 9 illustrates exemplary components used by various embodiments of the present invention. Although specific components are disclosed in computing system environment 900, it should be appreciated that such components are exemplary. That is, embodiments of the present invention are well suited to having various other components or variations of the components recited in computing system environment 900. It is appreciated that the components in computing system environment 900 may operate with other components than those presented, and that not all of the components of system 900 may be required to achieve the goals of computing system environment 900.

FIG. 9 shows a block diagram of exemplary computer system and corresponding modules, in accordance with one embodiment of the present invention. With reference to FIG. 9, an exemplary system module for implementing embodiments includes a general purpose computing system environment, such as computing system environment 900. Computing system environment 900 may include, but is not limited to, servers, desktop computers, laptops, tablet PCs, mobile devices, and smartphones. In its most basic configuration, computing system environment 900 typically includes at least one processing unit 902 and computer readable storage medium 904. Depending on the exact configuration and type of computing system environment, computer readable storage medium 904 may be volatile (such as RAM), non-volatile (such as ROM, flash memory, etc.) or some combination of the two. Portions of computer readable storage medium 904 when executed facilitate efficient execution of memory operations or requests for groups of threads.

Additionally, computing system environment 900 may also have additional features/functionality. For example, computing system environment 900 may also include additional storage (removable and/or non-removable) including, but not limited to, magnetic or optical disks or tape. Such additional storage is illustrated in FIG. 10 by removable storage 908 and non-removable storage 910. Computer storage media includes volatile and nonvolatile, removable and non-removable media implemented in any method or technology for storage of information such as computer readable instructions, data structures, program modules or other data. Computer readable medium 904, removable storage 908 and non-removable storage 910 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing system environment 900. Any such computer storage media may be part of computing system environment 900.

Computing system environment 900 may also contain communications connection(s) 912 that allow it to communicate with other devices. Communications connection(s) 912 is an example of communication media. Communication media typically embodies computer readable instructions, data structures, program modules or other data in a modulated data signal such as a carrier wave or other transport mechanism and includes any information delivery media. The term computer readable media as used herein includes both storage media and communication media.

Communications connection(s) 912 may allow computing system environment 900 to communication over various networks types including, but not limited to, fibre channel, small computer system interface (SCSI), Bluetooth, Ethernet, Wi-fi, Infrared Data Association (IrDA), Local area networks (LAN), Wireless Local area networks (WLAN), wide area networks (WAN) such as the internet, serial, and universal serial bus (USB). It is appreciated the various network types that communication connection(s) 912 connect to may run a plurality of network protocols including, but not limited to, transmission control protocol (TCP), internet protocol (IP), real-time transport protocol (RTP), real-time transport control protocol (RTCP), file transfer protocol (FTP), and hypertext transfer protocol (HTTP).

Computing system environment 900 may also have input device(s) 914 such as a keyboard, mouse, pen, voice input device, touch input device, remote control, etc. Output device(s) 916 such as a display, speakers, etc. may also be included. All these devices are well known in the art and are not discussed at length.

In one embodiment, computer readable storage medium 904 includes general-purpose computing on graphics processing units (GPGPU) program 906 and GPGPU runtime 930. In another embodiment, each module or a portion of the modules of GPGPU runtime 930 may be implemented in hardware (e.g., as one or more electronic circuits of GPU 110).

GPGPU program 906 comprises central processing unit (CPU) portion 920 and graphics processing unit (GPU) portion 922. CPU portion 920 executes on a CPU and may make requests to a GPU (e.g., to MMU 212 of GPU 202). GPU portion 922 executes on a GPU (e.g., GPU 202). CPU portion 920 and GPU portion 922 may each execute as a respective one or more threads.

GPGPU runtime 930 facilitates execution of GPGPU program 906 and in one embodiment, GPGPU runtime 930 performs thread management and handles memory requests for GPGPU program 906. GPGPU runtime 930 includes thread generation module 932, thread identifier generation module 934, and memory system 940.

Thread generation module 932 is operable to generate a plurality of threads based on a portion of a program (e.g., GPU portion 922 of GPGPU program 906).

Thread identifier generation module 934 is operable to generate a unique thread identifier for each thread and a unique thread group identifier for each group or warp of threads, as described herein.

Memory system 940 includes address generation module 942, memory allocation module 944, access request module 946, memory determination module 948, translation module 950, and memory access module 952. In one embodiment, memory system 940 facilitates access to memory (e.g., local graphics memory 114) by GPGPU program 906.

Address generation module 942 is operable to generate a respective base address for use by each of a plurality of threads. In one embodiment, address generation module 942 includes an address-generation mechanism operable to provide each thread with a corresponding stack base pointer inside the global memory region. In one embodiment, the address generation mechanism is specialized for the size of the address (e.g. 32, 40, 48, or 64 bit). The stack base pointer may be based on the thread identifier (e.g., thread serial number), thread group or warp identifier, streaming multiprocessor identifier, nested parallelism depth, and, in multi-GPU systems, a GPU identifier. In one exemplary embodiment, the address-generation mechanism may generate an address by concatenating the top 3-bits of an address in a memory request, with the thread identifier, thread group or warp identifier, streaming multiprocessor identifier, nested parallelism depth, and, in multi-GPU systems, a GPU identifier, and zeroes in the least significant bits.

In one embodiment, address generation module 942 is operable to process a set of load and store instructions along with load effective address (LEA) functionality that has the added functionality that the address operand is interpreted as an offset from an automatically generated per-thread base address. The load and store instructions may be zero based from the size of the local memory window (e.g., memory allocated for each thread of a group of threads). In one exemplary embodiment, load local and store local codes can be transcribed as LD.STACK and ST.STACK, respectively. It is noted that using different load and store instructions would allow embodiments of the present invention to used concurrently with conventional systems. In one embodiment, the address calculation for load and store instructions is performed by hardware (e.g., via concatenation).

Embodiments of the present invention are not limited to using the memory as a stack. For example, non-stack allocations are supported including thread local storage as standardized in C++ 11. A program executing may then have thread local storage (e.g., starting near zero) and storage for a stack (e.g., with a spare portion contiguous with the stack to support on-demand allocations to avoid page faults).

Memory allocation module 944 is operable to allocate memory for each of thread of a plurality of threads generated by thread generation module 932. In one embodiment, memory allocation module 944 comprises a control to specify the placement and width of a swizzled region (e.g., in SVA space 304) of global memory, as described herein. In one embodiment, a three bit value is compared with the top three bits of the virtual address and any address that matches the three bit value is considered in to be in the global memory region.

Access request module 946 is operable to receive a plurality of memory requests from a plurality of threads, as described herein. Memory determination module 948 is operable to determine whether each address of the plurality of memory requests corresponds to a predetermined portion of memory (e.g., swizzled memory allocated to a thread), as described herein.

Translation module 950 is operable to translate each respective address of the plurality of memory requests to a respective translated address if each address of the plurality of memory requests corresponds to the predetermined portion of memory. Each respective address of the predetermined portion of memory corresponds to a respective offset of a respective base address of each of the plurality of threads and each memory location corresponding to the respective offset is contiguous. In one embodiment, translation module 950 is operable to translate each address of the plurality of memory requests based on a bit of each respective address of the plurality of memory requests. In another exemplary embodiment, translation module 950 is operable to translate each respective address of the plurality of memory requests based a page table.

In one embodiment, translation module 950 includes conditional swizzle mechanism, specialized for the size of the address (e.g., 32, 40, 48, or 64 bit), inserted into the path to memory accessed by user programs (e.g., GPGPU program 906). The conditional swizzle mechanism may be at or before the MMU. For example, the conditional swizzle mechanism may be added to a load/store unit (LSU), a host, and a copy engine.

Memory access module 952 operable to perform or facilitate performance of the plurality of memory requests. In one embodiment, access module 952 is operable to respond to the plurality of memory requests in a single operation if each respective translated address corresponds to a contiguous portion of memory.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method for configuring memory for access, said method comprising:
accessing a portion of an executable program;
generating a group of threads comprising a plurality of threads based on said portion of said executable program;
assigning each thread of said plurality of threads a respective unique identifier;
allocating a respective portion of local memory to each of said plurality of threads, wherein said respective unique identifier is operable for determining a respective base address of said respective portion of local memory corresponding to a respective thread and wherein said respective portion of local memory is operable to be accessed by each of said plurality of threads and wherein each respective portion of local memory comprises a respective contiguous portion corresponding to an offset for each thread of said plurality of threads.

2. The method as described in claim 1 wherein said plurality of threads is operable to concurrently request access to said respective contiguous portion corresponding to said offset.

3. The method as described in claim 1 wherein each respective contiguous portion is contiguous for data stored for said group of threads for said offset.

4. The method as described in claim 1 further comprising:
assigning each thread of said group of threads a group identifier.

5. The method as described in claim 1 wherein each respective contiguous portion corresponding to said offset is operable to be returned in a single operation.

6. The method as described in claim 1 wherein said respective contiguous portion is operable to be accessed based on a translated address.

7. The method as described in claim 1 wherein said respective contiguous portion is operable to be accessed based on a page table.

8. A method for accessing memory, said method comprising:
receiving a request to access a portion of memory, wherein said request comprises a first address;
determining whether said first address corresponds to a thread local portion of memory;
in response to said first address corresponding to said thread local portion of memory, translating said first address to a second address; and
accessing said thread local portion of memory based on said second address, wherein said second address corresponds to an offset in said thread local portion of memory and wherein a contiguous portion of said thread local memory comprises memory allocated for said offset to each of a plurality of threads.

9. The method as described in claim 8 wherein said translating is based on a first set of bits of said first address and a second set of bits of said first address.

10. The method as described in claim 9 wherein said translating comprises swapping said first set of bits of said first address and said second set of bits of said first address.

11. The method as described in claim 8 wherein said translation is based on a page table.

12. The method as described in claim 8 wherein said determining whether said first address corresponds to said local portion of memory is based on a bit of said first address.

13. The method as described in claim 8 wherein said translating is performed prior to sending said second address to a memory management unit.

14. The method as described in claim 13 wherein said memory management unit is operable to return said contiguous portion of said thread local memory in a single operation.

15. The method as described in claim 8 wherein said first address is received from a memory management unit.

16. A system for efficient memory access, said system comprising:
an access request module operable to receive a plurality of memory requests from a plurality of threads;
a memory determination module operable to determine whether each address of said plurality of memory requests corresponds to a predetermined portion of memory;
a translation module operable to translate each respective address of said plurality of memory requests to a respective translated address for each address of said plurality of memory requests corresponding to said predetermined portion of memory, wherein each respective address corresponds to a respective offset of a respective base address of each of said plurality of threads and wherein each memory location corresponding to said respective offset is contiguous; and
an access module operable to perform said plurality of memory requests.

17. The system as described in claim 16 wherein said access module is operable to respond to said plurality of memory requests in a single operation if each respective translated address corresponds to a contiguous portion of memory.

18. The system as described in claim 16 wherein said translation module is operable to translate each address of said plurality of memory requests based on a bit of each respective address of said plurality of memory requests.

19. The system as described in claim 16 wherein said translation module is operable to translate each respective address of said plurality of memory requests based a page table.

20. The system as described in claim 16 wherein each of said plurality of threads execute in lock step.
